(19) United States
(12) Patent Application Publication
(10) Pub. No.: US 2026/0127624 A1
(43) Pub. Date: May 7, 2026

(54) ENTITY UNIQUE IDENTIFIER GENERATION

(71) Applicant: T-Mobile USA, Inc., Bellevue, WA (US)

(72) Inventors: Amina Noor, Sammamish, WA (US); Mohammad Mustafa Bari, Woodinville, WA (US)

(21) Appl. No.: 18/940,451

(22) Filed: Nov. 7, 2024

(51) Int. Cl. G06Q 30/0201

(52) U.S. Cl. CPC G06Q 30/0201

(57) ABSTRACT

This disclosure describes approaches that can be used to identify records in data sources that relate to the same entity, for example the same individual. The approaches herein can be used to identify entities in large datasets efficiently using a combination of blocking, prediction, and clustering. The approach herein can include assigning unique identifiers to entities. New or updated records can be processed and assigned either existing unique identifiers or new unique identifiers.

### BACKGROUND

Identifying data corresponding to the same entity across data sources is important but has proven challenging. This can be especially true for large datasets.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a drawing that schematically illustrates blocking according to some implementations.

FIG. 4 is a drawing that schematically illustrates clustering according to some embodiments.

FIG. 5 is a flowchart that illustrates an example process for training and deploying a matching model according to some embodiments.

FIG. 6 is a flowchart that illustrates an example process for assigning unique identifiers according to some implementations.

FIG. 7 shows a process for processing new or updated records according to some implementations.

FIG. 8 is a flowchart that illustrates an example processing for initial and incremental linking according to some implementations.

FIG. 9 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

Organizations often have a large amount of data related to entities, such as individual customers, business customers, leads, and so forth. This data can come from many different sources and can be stored in a variety of formats such as databases, spreadsheets, and so forth. Entity data can include internally-sourced data (e.g., account information), data provided by third parties (e.g., marketing firms, credit reporting firms), or both. Entity data can include a wide variety of identifying information, such as name, address, phone number, e-mail address, account number, and so forth. However, different sources of data can include different identifying information and, even when the same fields are included (e.g., name), errors, variations in data entry rules, etc., can mean that the same entity (e.g., the same person) has different identifying information in different data sources.

Organizations can make use of entity data for many purposes, such as upselling, cross-selling, retention, finding new customers, and so forth. It can be important to identify data records across sources that correspond to the same entity. For example, a database of leads data can include existing customers. Sending a new customer offer to an existing customer can result in a poor customer experience and wasted marketing money. Typically, there is no unique identifier that spans datasets. For example, an internal database of customers can include account numbers, but marketing data from an external source would generally not have account numbers.

The lack of a unique identifier can present significant challenges. For example, consider a wireless telecommunications company that offers both cellular service and wireless high speed internet (HSI) service. If the customers for the cellular phone service and the HSI service are stored in different databases and/or have different account numbers, it can be difficult to determine which cellular customers already have HSI. As a result, it can be difficult to target promotions or offers at customers who already have cellular service but do not have HSI. As another example, contact information for marketing campaigns can be purchased from third parties, but some of the individuals included in the contact information may already be customers, in which case it can be desirable to either not send marketing materials to those individuals or to send different marketing materials (e.g., instead of sending an offer to entice non-customers to switch, the company can send an offer to add another line to their existing plan or to upgrade their plan).

A universal identifier can enable an organization to recognize the same individual across various database systems, even if their information appears differently (e.g., variations in name, contact details, or other data entries) in different databases. This can help ensure a holistic view of an individual (e.g., a customer) and can lead to improved data accuracy and integrity across an organization. It can also help to consolidate customer profiles, enabling better decision making and analysis.

With the ability to correctly identify unique individuals, marketing efforts can be better targeted and more efficient. This can reduce the risk of sending multiple promotional messages to the same person, preventing overexposure and improving the relevancy of outreach. By optimizing who is included in marketing campaigns, marketing resources can be focused on a reaching a broader and more diverse audience while targeting an audience that is more likely to find the marketing campaign relevant.

By eliminating duplicate marketing efforts and unnecessary customer contacts, an organization can significantly reduce its marketing expenditures. Cost savings can come from fewer campaign materials, lower ad spends, and/or reduced operational workloads. These savings can be used for other purposes, such as other strategic initiatives to further enhance marketing effectiveness.

Customers who receive repeated marketing messages can become frustrated or develop a negative perception of a brand. By resolving IDs and reducing the likelihood that individuals are contacted more than once or with poorly targeted marketing campaigns, an organization can reduce the likelihood of customer annoyance. This can improve the overall customer experience, leading to higher satisfaction and potentially increased brand loyalty and improvement in associated key performance indicators.

A significant benefit of the approaches described herein is an improved ability to track customers throughout their journeys. For example, if a customer activates two voice lines, adds an internet line three months later, and then disconnects one of the voice lines, the universal ID can help ensure consistent tracking across databases, making it easy to see which services a customer currently has and has had in the past. For example, by observing that the customer previously had two lines and now only has one, a company might identify the customer as a good target for a win-back campaign directed at bringing back customers who have churned. The win-back campaign can include, for example, an offer for a discounted service or can be aimed at informing the customer of improved services in their area.

In some cases, organizations have data spread across a large number of databases. This can be especially true when a company offers many different types of products and/or services, when a company maintains an internal marketing database (e.g., collected by asking people for contact information at checkout), or when a company acquires another company and inherits its customer data. As an example, a wireless telecommunications company may have one database for postpaid customers, another for HSI customers, another for prepaid customers, another for customers of a mobile virtual network operator controlled by the company, and another for customers of another carrier that was acquired by the company. The same customer may appear in multiple databases depending upon the services they currently have or have had in the past.

Another issue that can arise is a single entity (e.g., a single individual) having multiple records in a dataset. For example, a marketing dataset might include multiple records for the same person (e.g., reflecting prior addresses, maiden name, different spellings). In the context of a wireless telecommunications company, a customer database can have multiple records for the same person if the person signs up for a family plan and has multiple lines. In some cases, a line can be associated with multiple people. For example, if a first individual signs up for multiple lines, all of the lines can initially be assigned to the first person (e.g., the account holder). The first person may update the information for one or more of the lines to indicate the name of the person who actually uses the line. Thus, a particular line (e.g., a particular phone number) can be associated with both the account holder and the person who uses the line.

Another consideration is that what is true can change over time. For example, a person might change addresses over time, change phone numbers, have multiple e-mail addresses, or even change their name (e.g., changing their last name when they get married or divorced). This can present a significant challenge as it means that a single entity (e.g., a single person) can have many records that have limited shared information, making it difficult to identify when two records correspond to the same entity.

Failure to understand how entities in different data sets are related can result in wasted money (e.g., money wasted on marketing campaigns), customer frustration (e.g., a customer may become upset if they receive marketing materials for a promotion they are not eligible for), and so forth. Accordingly, there is a need for approaches that match entities across datasets. In some implementations, entities can be assigned unique identifiers (UIDs), which can act as a key for identifying the same entity across different datasets or even within a single dataset.

There are many challenges associated with matching entities across datasets, within a dataset, or both. Data quality issues, legitimate changes in what is true about entities, ambiguities, different data structures and formats, different data entry standards, algorithmic challenges, and so forth can present significant challenges. One way to match records is strict comparison of one or more fields. That is, comparisons can be deterministic in that certain fields are required to match exactly in order for two records to be considered to belong to the same entity. As described in more detail herein, this can be problematic as there can be variations in how data is entered. Thus, requiring exact matches can result in a large number of false negatives, in which entities that are the same are identified as different.

Even when data sets have overlapping identifying information fields, such as first name, last name, etc., there can be inconsistencies or errors that make matching difficult. For example, a first dataset and a second dataset can each include a “first name” field, but the same person can have different names in different datasets (e.g., “Will” vs. “William”), or a name can be entered differently (e.g., “J Smith” vs. “John Smith”). Typographical or scrivener's errors can also present challenges, such as misspelled street names, alternate spellings of a name (e.g., “Megan” instead of “Meghan”), and so forth. These issues can be especially pronounced for information that is provided by one person but input by another, such as information provided over the phone or at a retail store, as opposed to being entered directly by the entity to which the information pertains (e.g., by customer filling out a form). Missing values can also present challenges. In many cases, such as when dealing with numerical data that follows clear patterns or where small errors are of limited impact, missing values can be imputed. However, for factual data such as names, account numbers, addresses, etc., missing values generally cannot be imputed. For example, knowing that someone is named “John Smith” and lives in Baltimore provides no useful indication of the relevant street address, nor does information about other John Smiths or other people who also live in Baltimore. Ambiguity can also present significant challenges. For example, it can be difficult to distinguish between individuals with common names. Additional identifying information can help to distinguish such individuals, but it can still remain a challenge to differentiate between individuals who share common names, cities, etc.

Described herein are various techniques that can be used to match records corresponding to the same entity in a dataset or across multiple datasets. For example, probabilistic matching techniques can be used to match records that are likely to correspond to the same entity.

Pairwise comparisons can be used to identify matching entities. For small datasets, pairwise comparisons of all the records in multiple datasets, a combined dataset, or a single dataset can be feasible. However, for large datasets that include many (e.g., millions or billions) of records, performing pairwise comparisons of all records can be infeasible. For example, the number of pairwise comparisons that need to be done to compare all records in a dataset grows approximately as the square of the number of records in the dataset. For example, for a dataset with 10 records, there are (10)(9)/2=45 pairwise comparisons, while for a dataset with 100 records, there are (100)(99)/2=4,950 possible pairwise comparisons. For large organizations with millions or even billions of records, the computational power and time needed to perform pairwise comparisons of all records can be infeasible. Moreover, it may be known ahead of time or fairly easily determined that two records relate to different entities. For example, Jane Smith in Madison, WI, is highly unlikely to be the same person as John Williams in Pasadena, CA.

In some implementations, the approaches herein can utilize blocking to divide up a larger dataset into smaller groups of data, and pairwise comparisons can be performed within these groups. Blocking can be done in a deterministic or probabilistic manner, as can pairwise comparisons to identify matches within groups. When probabilistic matching is used, thresholds can be set for when records should be determined to be matches.

In some implementations, data can be pre-processed before blocking. For example, dates can be converted to a standardized format, zip codes can be converted (e.g., from ZIP+4 to just ZIP, or vice versa), titles and/or suffixes can be removed, and so forth. In some implementations, address information is combined from multiple fields to a single field, or data in one field is split across multiple fields (e.g., one for street address and one for apartment or unit). In some implementations, leading and/or trailing whitespace is removed or certain punctuation is removed (e.g., to change “Apt.” to “Apt”). Pre-processing can address some common data issues that could cause field values in records not to match despite representing the same thing (e.g., the same address, same name, or same date of birth).

In a blocking step, blocking rules can be used to group records into groups that contain possibly related records. This can be important as the number of possible pairwise comparisons can be very large and infeasible to perform when there is a large number of records. Blocking can take advantage of the fact that, generally, records that are likely to be related to the same entity will share at least some common values for certain attributes. For example, if two records both have the same first and last name, they are more likely to correspond to the same individual than if neither the first name nor the last name match.

Blocking rules can be relatively strict or loose. In some implementations, relatively broad similarity measures are used for blocking to help reduce that likelihood that records that are related to the same entity are inadvertently excluded from comparison and thus unable to be matched. It can generally be expected that that blocking may group together many records that, while having some similarity, are not actually all related to the same entity.

In some implementations, blocking rules are cascaded (e.g., multiple alternative rules can be provided). In some implementations, a blocking rule is probabilistic. In some implementations, a blocking rule is deterministic. In some implementations, blocking rules include various levels. For example, a blocking rule can give a higher weight to exact matches than to partial matches, while still giving partial matches higher weight than non-matches. This can be significant because, for example, two records that correspond to the same entity may have different information. For example, one record may have an individual's full first name (e.g., “William”) while another has a shortened version (e.g., “Will”). Blocking rules can be chosen to enable a relatively high rate of true match identification while still meaningfully reducing the number of pairwise comparisons to be made. In some implementations, a relatively large number of relatively specific blocking rules are used, while in other implementations, a smaller number of relatively broad rules is used. A relatively narrow rule can use, for example, exact matching, while a relatively broad rule can use fuzzier matching techniques, as described in more detail herein. While relatively strict, narrow rules such as equals can be attractive because they can be executed quickly, such strict rules can result in the exclusion of many records that are in fact matches. Fuzzy techniques can be relatively computationally intensive as they can require some processing of records before determinations as to blocking can be made.

In some implementations, blocking is applied to a single dataset (which can, in some cases, be a combination of datasets). In some implementations, blocking is applied to multiple datasets. For example, the same blocking rules can be applied to multiple datasets, and corresponding blocks can be used for pairwise comparisons.

After blocking, prediction can be used to identify potential matches within blocks. Prediction can use deterministic comparisons or probabilistic comparisons, or a combination of both. As described herein, purely deterministic rules can have significant drawbacks as there can be differences between records even though they correspond to the same entity. Different fields can have different weights associated therewith. For example, social security number, account number, or phone number may be better indicators of whether or not records match (i.e., correspond to the same entity) than other fields, such as first name, last name, or city. In some implementations a comparison can output one value if the records match some comparison criterion and another value if they do not. In some cases, multiple levels of comparison can be made, with different weights or values assigned to each. As an example, name can be assigned one value (e.g., 2) if the values are an exact match, another value (e.g., 1) if the values have a Levenshtein distance of 1, and another value (e.g., 0) otherwise. In some implementations, multiple comparisons can be made. This is merely an example, and it will be appreciated that more complex comparisons, more levels, and/or more comparisons can be made. For example, a comparison can include four levels, such as exact match, Jaro-Winkler greater than a threshold, Levenshtein less than a second threshold, and other. The different comparisons can have different values or weights, or some comparisons can have the same weight or value (e.g., Jaro-Winkler and Levenshtein comparisons can be assigned equal value).

Determining appropriate weights for different fields can be challenging. As described herein, different fields can have different predictive power for determining if two records correspond to the same entity. Additionally, values of fields can have significant skew, which can impact their predictive value. For example, “Los Angeles” as a city value is significantly less useful for identifying matching records than another city such as “Hoboken,” as Los Angeles has a population more than sixty times that of Hoboken. In some implementations, term frequency adjustments are used to account for the different predictive power of different values. Accordingly, as different fields and different values can have different predictive power, there is a need to provide a model that can consider these differing predictive powers when determining whether two records are likely matches. In some implementations, term frequency adjustments may not be used. For example, depending on the particular data and the fields used for matching, term frequency adjustments may provide only limited value while being associated with significant computational demand.

Record matching (linking) can be determined using a model. The model can define which records to compare (e.g., using blocking rules to divide records into blocks) and how to perform comparisons within blocks (e.g., which features to compare, how they should be compared, and what their relative weights should be). The model can be trained to determine probabilities that records are linked. Training can include estimating the probability that two randomly-selected records match, estimating unmatched values (u values), representing the likelihood that two non-matching records have matching values for a field, and estimating match values (m values), representing the likelihood that a value for a field matches for two records that in fact correspond to the same entity. In some implementations, the probability that two randomly-selected records match is known or at least approximately known and can be defined rather than algorithmically estimated. When the probability is unknown, it can be estimated by applying matching rules and an estimated recall. u probabilities can be estimated using random sampling. Estimating u values can take advantage of the fact that, for many datasets (e.g., customer datasets, prospect datasets), most records are not matches, and it can thus be assumed that any two randomly-selected records are non-matches. u values can be estimated for different comparison levels. Comparison levels can describe the different comparison techniques used for comparisons; that is, a comparison can specify a field to be compared, and comparison levels can specify the techniques to be used to compare the values of the field. As an example, for first name as the field with comparison levels of exact match, Levenshtein distance <=1, and other, a system can estimate u values for each comparison level, reflective of the likelihood that two records that do not match have the same (equal) first name, first names that differ by at most one character, and are different by more than one character.

Estimating m values can be challenging, as these values relate to actual matches. If training data is labeled, m values can be estimated directly. However, in many cases, training data is unlabeled, and thus m values have to be estimated in other ways. In some implementations, a system can utilize an expectation maximization algorithm to estimate m values. The expectation maximization algorithm is an iterative method that can be used to find maximum likelihood estimates of parameters in statistical models and can be particularly useful when data is incomplete or missing. The expectation maximization algorithm can alternate between estimating missing values (the expectation step) and updated model parameters (the maximization step) until convergence.

As discussed herein, there are many potential comparison methods available. Exact matching can be the simplest form of matching. Other methods or metrics for string comparisons can include Levenshtein distance, Damerau-Levenshtein distance, Jaro similarity, Jaro-Winkler similarity, Jaccard similarity, and so forth. Levenshtein distance describes the minimum number of insertions, deletions, and substitutions needed to make one string from another. Damerau-Levenshtein distance is similar, but also includes transpositions. Transpositions can be useful as manually-entered data may contain simple transpositions of characters, such as “San Farncisco” instead of “San Francisco.” Jaro similarity accounts for the number and order of matching characters, and transpositions needed to get to one string from another. This can be useful when all characters are considered equally important. Jaro-Winkler is similar but gives higher weight to the earlier characters in strings. Jaro-Winkler can be particularly useful for names, which are sometimes shortened (e.g., Will instead of William). Jaccard similarity considers the number of shared characters in strings as a portion of the total unique characters in the strings. Jaccard similarity can be useful for strings such as address, which can be split into multiple components (e.g., number, street name, direction, city, state, zip).

Phonetic matching can also be important. Phonetic matching determines whether two strings are phonetically similar. This can be especially useful for names, which may sound the same or very similar while being spelled differently, such as Steven and Stephen or Katherine and Catherine. Some examples of phonetic matching algorithms include Soundex, Metaphone, and Double Metaphone. Soundex assigns codes to words based on their sound. Metaphone improves upon Soundex by taking into account the sound of the entire word, rather than only the first letter and consonants. Double Metaphone extends upon Metaphone by generating two codes for each word, representing different pronunciations. Double Metaphone can be beneficial for handling a wider range of languages, accents, and so forth. In some implementations, phonetic matching is used for blocking. Phonetic matching can be advantageous because a phonetic representation can be determined directly from a value, while fuzzy string comparisons require pairwise comparisons of two strings. As an example, the Soundex for Johnson (J525) and Jonson (J525) can be computed directly from the values. Checking if the two Soundex values are equal can be a relatively fast and efficient operation. On the other hand, determining the Levenshtein distance (1) requires comparing Johnson to Jonson and calculating a value based on these two inputs. Consider a dataset with 100 records. Calculating Soundex values for all 100 names in the records can be done in 100 operations of a Soundex calculation function. In contrast, 4,950 pairwise Levenshtein distance calculations would be needed to compute Levenshtein distances for all combinations of all 100 names.

The approaches described herein provide nearly limitless possibilities for matching entities. The inventors have advantageously discovered similarity measures, thresholds, and so forth that can be used to block records and predict common entities with a high degree of accuracy. For example, in some implementations, blocking is done using Double Metaphone for address, dropping street number from the address. For example, 910 Elm Road and 9 Elm Road would be considered as matches for blocking purposes, as would 567 Willow Avenue and 2756 Willough Avenue. Equal name Soundex can be used for blocking. Thus, for example, Katherine and Kathryn can be treated as matches, as can Stephen and Steven or Sreekanth and Shreekant.

Stricter similarity measures can be used for prediction. For example, names can be compared using Jaro-Winkler similarity and Levenshtein distance. In some implementations, a threshold Jaro-Winkler similarity of 0.8, 0.85, 0.9, 0.95, etc., can be used, for example 0.85. A threshold Levenshtein distance can be set relatively low, for example 1, 2, 3, etc., for example 1. A low threshold (e.g., <=1) can enable matching for simple misspellings or variation (e.g., Sarah vs. Sara, John vs. Jon, Amina vs. Aamina) while preventing matching for names with large differences in spelling.

As described herein, certain values can be expected to remain relatively static for the same entity, while other values can change over time. For example, first name and date of birth typically do not change, while address may change as people move and last name may change when people marry or divorce.

Within the specific context of data for a wireless telecommunications company, the inventors have found that the following entity requirements can advantageously be used to determine matches:
The same billing account number and mobile station international subscriber directory number (MSISDN((e.g., phone number) combination should not occur for multiple entities.
Two different first names cannot be a part of one entity. However, nicknames, shortened names, aliases, and so forth are permitted.
An entity can have two different last names, to account for marriages and divorces.
One entity can have different addresses.

It will be appreciated that these rules can be probabilistic. That is, two first names being the same does not necessarily mean that they are identical because, as described herein, typographical errors, nicknames, and so forth can result in the same person having more than one first name in a dataset.

After prediction, records can be grouped together into clusters, for example based on a predicted matching level. Individual records can be treated as nodes on a graph, and a collection of nodes can form a cluster. Nodes can be connected by edges. Edges can be labeled with a likelihood that two nodes relate the same entity. A threshold can be adjusted to determine when an edge should be present (e.g., when records should be linked). For example, a minimum likelihood can be required before two records are linked by an edge. Setting this threshold can be significant as if it is set too high, records corresponding to the same entity can be split into multiple clusters, while if it is set too low, records corresponding to different entities can be grouped into the same cluster. Thus, for example, if set too high, the same person can appear to be two different people or if set too low, multiple people can appear to be the same person.

Various metrics can be used to evaluate clusters and edges. For example, edges can be evaluated by checking true positive rates (e.g., actual matches are connected), true negative rates (e.g., non-matches are not connected), false positive rates, false negative rates, accuracy recall, specificity, precision, negative predictive value, F-score, P4 score, and so forth. In some implementations, metrics such as cluster size, connectedness, and so forth can be used. For example, a large number of nodes (e.g., records) in a cluster may indicate that matching rules are too loose if it would not be expected for there to be so many records related to the same entity. Connectedness measures how many edges there are in a cluster as a fraction of the total possible edges. Very high connectedness can indicate a high likelihood that the records actually relate to the same entity, but may also indicate that blocking rules, prediction rules, etc., are too restrictive and fail to match some true matches. In contrast, low connectedness can indicate that rules are too loose and records that are not true matches are potentially being joined together into the same cluster.

After clustering, each entity (e.g., each cluster) can be assigned a unique identifier. In some implementations, the unique identifier (UID) is determined based on information within the records (e.g., name, date of birth, etc.). In other implementations, the UID is randomly generated or otherwise unconnected to the underlying values in records within the cluster. The UID can then be used when there is a need to find an entity across datasets or within a dataset. In some implementations, records and their associated UIDs are stored in a dataset (a “golden dataset”).

Often, data is not static. For example, new customers can sign up for a service, existing customers may update their records (e.g., when they move or change names), and so forth. In some implementations, the methods described herein can be used to update the golden dataset. For example, as new or updated records become available, a system can process the records, performing blocking, prediction, and clustering. These new or updated records can be linked against the golden dataset (or against data used to produce the golden dataset). If the new or updated records correspond to new entities, new UIDs can be generated and assigned to the records corresponding to new entities. If the records correspond to an existing entity, the UID for the existing entity can be assigned to the records.

### Wireless Communications System

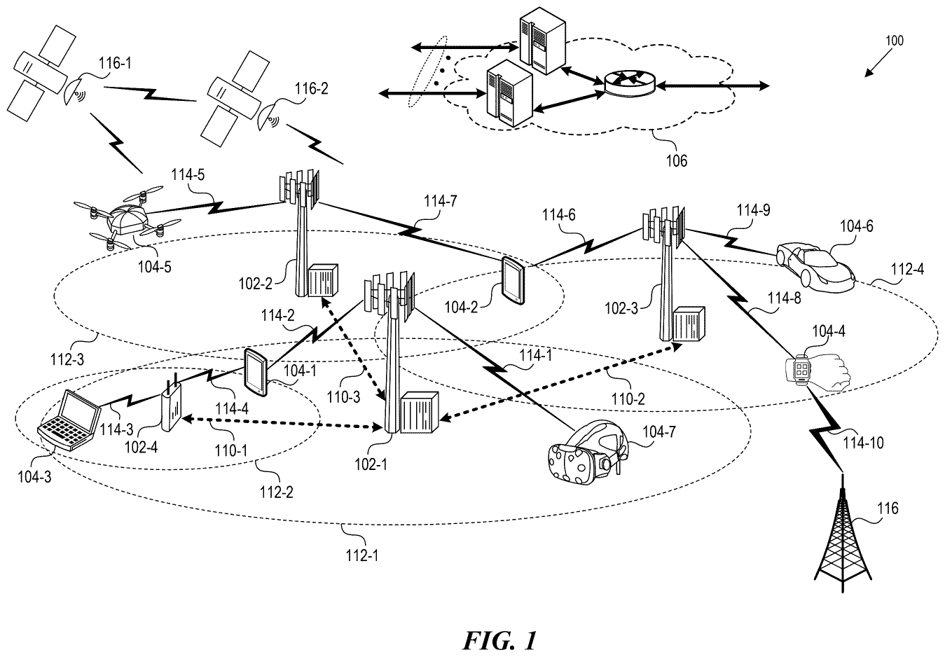

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

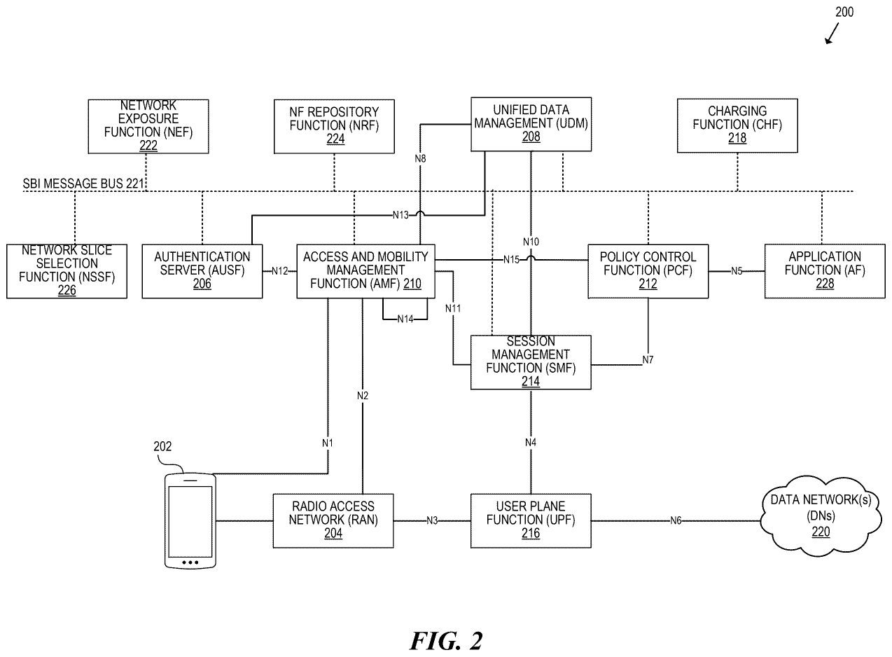

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Example Implementations

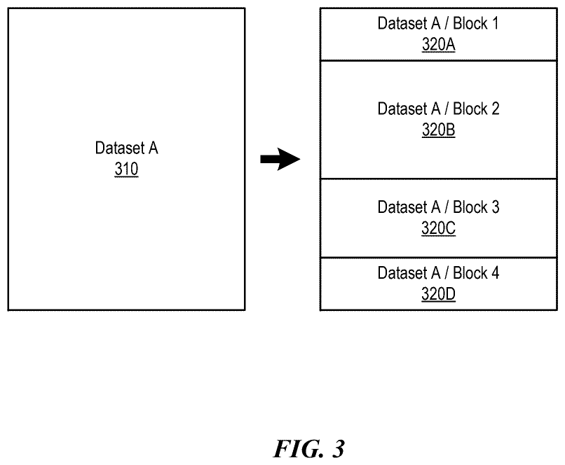

FIG. 3 is a drawing that schematically illustrates blocking according to some implementations. In FIG. 3, a dataset 310 is processed using blocking rules to generate four blocks 320A-320D, each comprising a subset of the dataset 310. As described herein, the blocks can be determined by applying one or more blocking rules, which can be deterministic, probabilistic, or a combination of both. As an example, a blocking rule can be “(equal address double metaphone) OR (equal name Soundex).” In some implementations, numbers in addresses are not considered. In some implementations, only first name is considered. Predictive pairwise comparisons can be performed for records within each block 120A-120D.

As an example, the inventors have found that blocking on last name and address, account number and phone number, account number and last name, phone number and last name, and last name and email result in blocks that are sufficiently small to be computationally feasible for pairwise comparisons yet broad enough that true matches are highly likely to appear in the same block. The inventors have also found that the following prediction rules provide high accuracy for identifying true matches within blocks: jw(firstName₁, firstName₂)>0.9 AND (jw(address₁, address₂)>0.9 OR jw(email₁, email₂)>0.9 OR ban₁=ban₂ OR phone₁=phone₂), where jw(p₁, p₂) is the Jaro-Winkler similarity between parameters p₁ and p₂.

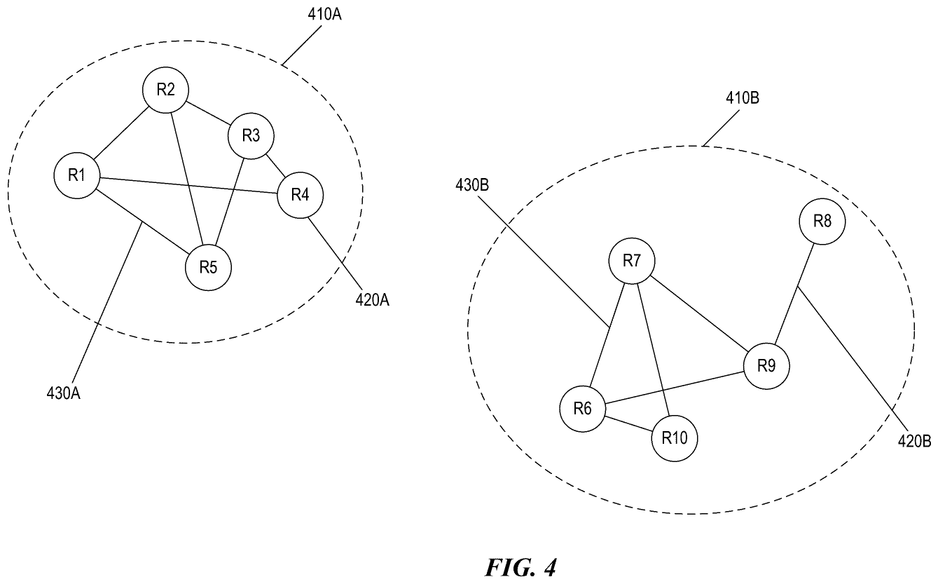

FIG. 4 is a drawing that schematically illustrates clustering according to some embodiments. As described herein, records (nodes) can be clustered together based on the likelihood that two records correspond to the same entity. Entities can be represented as clusters. In FIG. 4, two clusters (e.g., two entities) 410A and 410B are illustrated. Each cluster comprises nodes 420A and 420B. The nodes are connected by edges 430A and 423B. As described herein, whether or not two nodes are connected by an edge can depend on the likelihood that the nodes correspond to the same entity, for example as determined by performing one or more comparisons in a prediction step. The edges can have weights indicating the strength of the connection between two nodes (e.g., the likelihood that the nodes are in fact related to the same entity). A graphical representation such as the one shown in FIG. 4 can be useful because, for example, it can help identify cases where clusters have an unusually large or small number of nodes, or where a cluster includes poorly connected nodes. As an example, in the cluster 410B, the node labeled R8 is only connected to one other node (R9) in the cluster. This can indicate, for example, that the R8 node is not actually related to the same entity as the other nodes in the cluster 410B, although in some cases the node may in fact belong in the cluster 410B and can have relatively low connectedness due to other reasons, such as missing data, typographical errors, and so forth that can reduce a model's confidence that it is related to other nodes in the cluster.

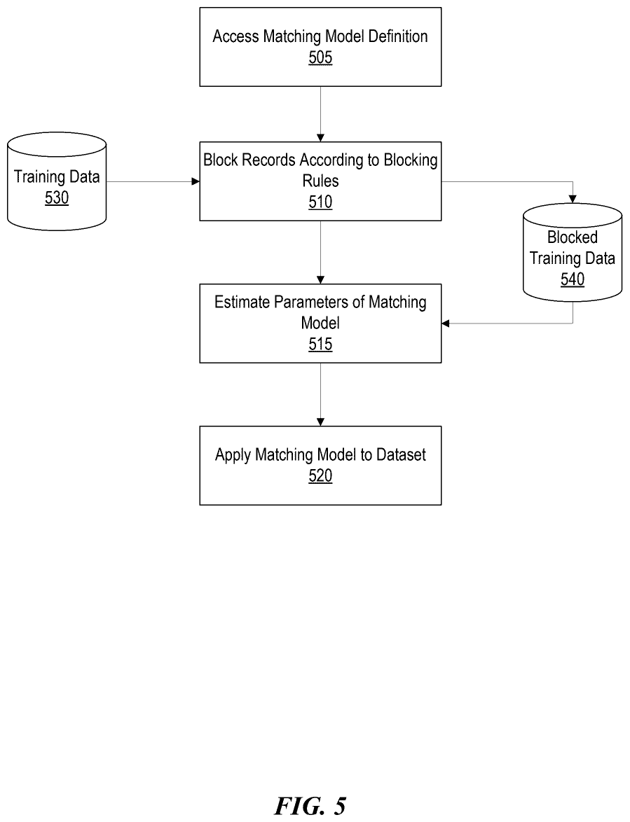

FIG. 5 is a flowchart that illustrates an example process for training and deploying a matching model according to some implementations. At operation 505, a system can access a definition for a matching model. The definition can specify blocking rules, comparisons, comparison levels, and so forth. For example, the comparisons can specify which fields to compare, and the comparison levels can specify how to compare values in the fields (e.g., exact matching, particular fuzzy matching techniques, etc.). At operation 510, the system can block records in training data 530 according to one or more blocking rules. The blocking rules applied at operation 510 can be the same as the blocking rules that are used in production or they can be different from the production blocking rules. The system can generate blocked training data 540. At operation 515, the system can estimate model parameters using the blocked training data 540 (e.g., the likelihood that two random records match (if not predefined in the model), m values, and u values). These values can be used to determine match weights for the different parameters (e.g., fields) that are compared. In some implementations, estimation can also include estimating term frequency adjustments, for example as described herein.

After training at operation 515, the model can be deployed and applied to a dataset (e.g., a production dataset) at operation 520. The production dataset can be the same as the training data 530 or can be different. In some cases, the training data 530 comprises a subset of a production dataset.

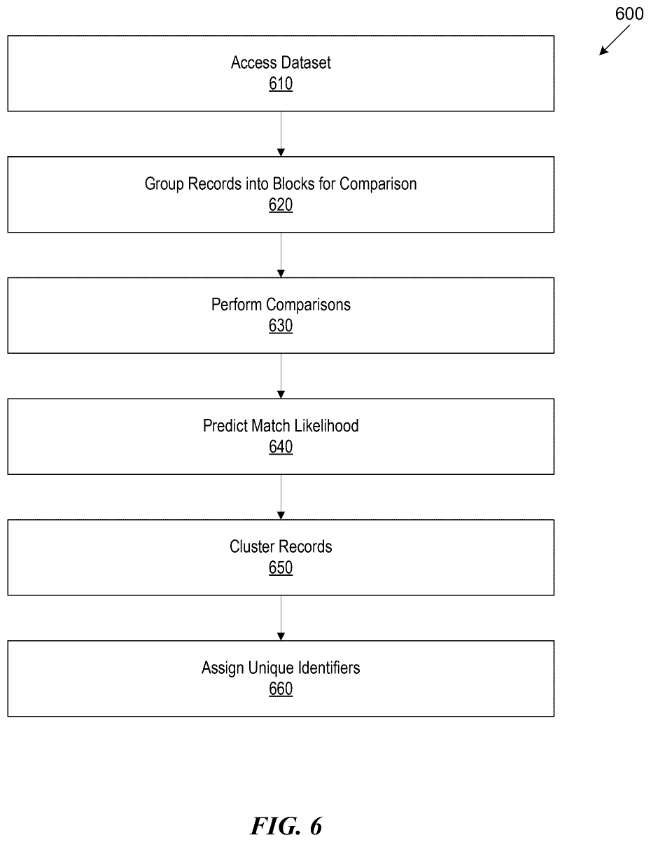

FIG. 6 is a flowchart that illustrates an example process 600 for assigning unique identifiers according to some implementations. At operation 610, a system can access a dataset. In some implementations, a single dataset is accessed. In some implementations, multiple datasets are accessed. At operation 620, the system can group records in the dataset(s) into blocks based on one or more blocking rules. At operation 630, within each block, the system can perform comparisons of the records within the blocks. The comparisons can include comparisons of one or more fields in the dataset. At operation 640, the system can predict match likelihoods for records based on the comparisons. At operation 650, the system can cluster records, for example based on match weights as described herein. The clustering can be based on, for example, a score or other metric indicating likelihood that records correspond to the same entity. At operation 660, the system can assign a unique identifier to each cluster. In some implementations, unique identifiers are randomly generated.

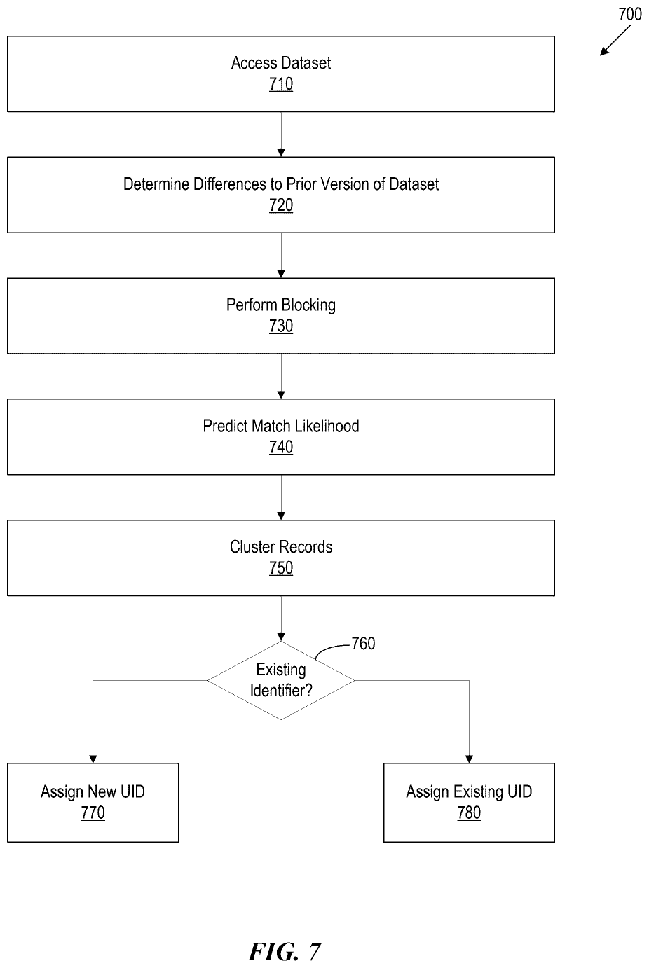

FIG. 7 shows a process 700 for processing new or updated records according to some implementations. At operation 710, a system can access a dataset. At operation 720, the system can identify differences between the dataset and a prior version of the dataset, for example by comparing the dataset to a previous copy or based on one or more fields in the dataset (e.g., created time or modified time). At operation 730, the system can perform blocking on the new or updated records. At operation 740, the system can make perform comparisons within the blocks and predict a match likelihood. At operation 750, the system can cluster matching records. At operation 760, the system can determine if there is an existing unique identifier for each cluster. Is not, at operation 770, the system can assign a new UID to the cluster. If not, at operation 780, the system can assign an existing UID to the cluster.

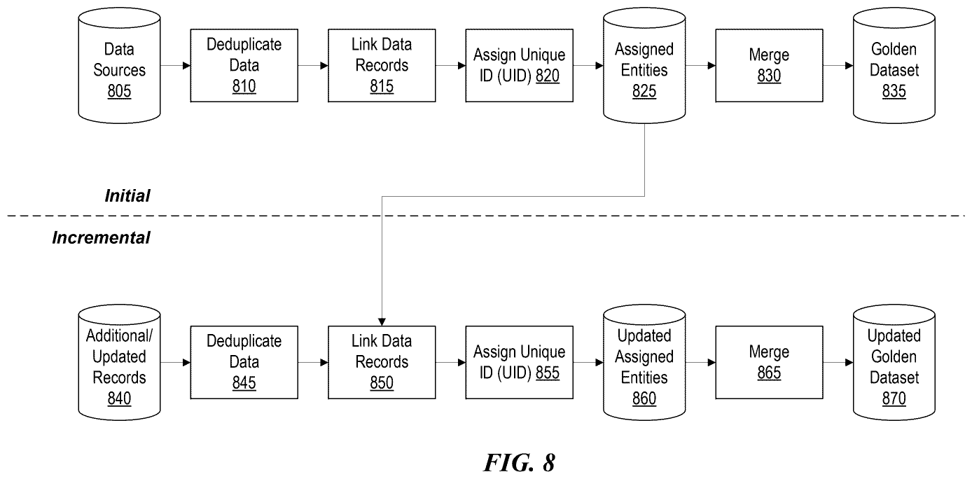

FIG. 8 is a flowchart that illustrates an example process for initial and incremental linking according to some implementations. At operation 810, a system can deduplicate data from data sources 805. At operation 815, the system can link data records in the deduplicated data, for example as illustrated in FIG. 6. At operation 820, the system can assign unique identifiers (UIDs) to each entity in the linked data records to produce an assigned entities data 825. At operation 830, the system can merge data to produce a golden dataset 835. For example, there can be multiple records associated with each UID, which can be merged into a single record. For example, there can be a set of pre-defined rules that prioritize attributes based on data source, which can be used when merging records to form the golden dataset.

At operation 845, the system can access a set of additional or updated records 840 and deduplicate the records 840. At operation 850, the system can link the new records and the assigned entities data 825. For example, the system can apply blocking rules, predictions, and clustering as described herein to the records 840. At operation 855, the system can assign UIDs to the new records. The UIDs can be existing UIDs (e.g., if records in the records 840 correspond to existing entities in the golden dataset 835, for example to previously identified clusters) or new UIDs (e.g., if records in the records 840 correspond to entities not in the golden dataset 835). At operation 865, the system can carry out a merge operation to produce an updated golden dataset 870.

### Computer System

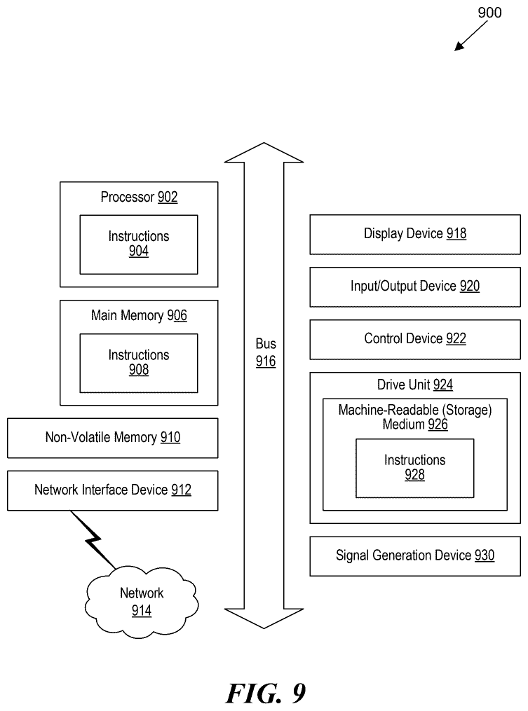

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A method for generating unique identifiers for entities in datasets, the method comprising:
accessing a first dataset and a second dataset comprising a plurality of records;
pre-processing the first dataset and the second dataset,
wherein pre-processing comprises removing duplicate records from the first dataset and the second dataset, and
wherein pre-processing comprises converting dates to a standardized format;
applying one or more blocking rules to the plurality of records to determine a plurality of blocks each comprising a subset of the plurality of records,
wherein the one or more blocking rules comprise equal address double metaphone and equal first name Soundex, wherein records are grouped into a same block if either rule is satisfied;
applying, for each block of the plurality of blocks, one or more pairwise comparisons of fields in the records in the block to determine one or more match weights,
wherein each pairwise comparison comprises a comparison field and at least one comparison level,
wherein each comparison level is associated with a match weight, wherein the match weight is determined at least in part by training a model using an expectation maximization algorithm;
determining, for at least one field, a term frequency adjustment,
wherein the term frequency adjustment is used to adjust a match weight based on a frequency of a value of the at least one field in the first dataset and the second dataset;
clustering the records of each block based on the determined match weights in a first set of clusters, wherein records are clustered if the match weights are above a
threshold value;
assigning a unique identifier (UID) to each cluster;
accessing a set of new records;
applying the one or more blocking rules to the new records to group the new records into a second plurality of blocks;
applying the one or more pairwise comparisons to the new records in each of the second plurality of blocks;
clustering the new records based on the pairwise comparisons to generate a second set of clusters;
determining, for each cluster of the second set of clusters, if the cluster corresponds to a cluster of the first set of clusters;
when the cluster of the second set of clusters corresponds to a cluster of the first set of clusters, assigning the UID of the cluster of the first set of clusters to the
cluster of the second set of clusters; and
when the cluster of the second set of clusters does not correspond to a cluster of the first set of clusters, assigning a new UID to the cluster of the second set of clusters.

2. A method for generating unique identifiers for entities in datasets, the method comprising:
accessing a first dataset and a second dataset comprising a plurality of records;
pre-processing the first dataset and the second dataset,
wherein pre-processing comprises removing duplicate records from the first dataset and the second dataset;
applying one or more blocking rules to the plurality of records to determine a plurality of blocks each comprising a subset of the plurality of records;
applying, for each block of the plurality of blocks, one or more pairwise comparisons of fields in the records in the block to determine one or more match weights,
clustering the records of each block based on the determined match weights in a first set of clusters, wherein records are clustered if the match weights are above a threshold value; and
assigning a unique identifier (UID) to each cluster.

3. The method of claim 2, further comprising:
accessing a set of new records;
applying the one or more blocking rules to the new records to group the new records into a second plurality of blocks;
applying the one or more pairwise comparisons to the new records in each of the second plurality of blocks;
clustering the new records based on the pairwise comparisons to generate a second set of clusters;
determining, for each cluster of the second set of clusters, if the cluster corresponds to a cluster of the first set of clusters;
when the cluster of the second set of clusters corresponds to a cluster of the first set of clusters, assigning the UID of the cluster of the first set of clusters to the cluster of the second set of clusters; and
when the cluster of the second set of clusters does not correspond to a cluster of the first set of clusters, assigning a new UID to the cluster of the second set of clusters.

4. The method of claim 2, wherein the one or more blocking rules comprise a phonetic matching rule.

5. The method of claim 2, wherein the one or more blocking rules comprise equal address double metaphone and equal first name Soundex, wherein the records are grouped into a same block if either rule is satisfied.

6. The method of claim 2,
wherein each pairwise comparison comprises a comparison field and at least one comparison level,
wherein each comparison level is associated with a match weight, wherein the match weight is determined at least in part by training a model using an expectation maximization algorithm.

7. The method of claim 6, wherein the comparison field comprises first name and the comparison levels comprise Jaro-Winkler similarity and Levenshtein distance.

8. The method of claim 2, further comprising:
determining, for at least one field, a term frequency adjustment,
wherein the term frequency adjustment is used to adjust a match weight based on a frequency of a value of the at least one field in the first dataset and the second dataset.

9. The method of claim 5, wherein numbers in address values are not considered.

10. The method of claim 2, wherein the first dataset and the second dataset comprise a customer dataset and a marketing dataset, wherein the customer dataset includes account numbers associated with customers.

11. The method of claim 2, wherein preprocessing further comprises at least one of: converting dates to a standardized format, removing leading whitespace, removing trailing whitespace, removing prefixes, or removing suffixes.

12. A system for generating unique identifiers for entities in datasets, the system comprising:
at least one hardware processor; and
a non-transitory medium having instructions stored thereon that, when executed by the at least one hardware processor, cause the system to:
access a first dataset and a second dataset comprising a plurality of records;
pre-process the first dataset and the second dataset,
wherein pre-processing comprises removing duplicate records from the first dataset and the second dataset;
apply one or more blocking rules to the plurality of records to determine a plurality of blocks each comprising a subset of the plurality of records;
apply, for each block of the plurality of blocks, one or more pairwise comparisons of fields in the records in the block to determine one or more match weights,
cluster the records of each block based on the determined match weights in a first set of clusters, wherein records are clustered if the match weights are above a threshold value; and
assign a unique identifier (UID) to each cluster.

13. The system of claim 12, wherein the instructions are further configured to cause the system to:
access a set of new records;
apply the one or more blocking rules to the new records to group the new records into a second plurality of blocks;
apply the one or more pairwise comparisons to the new records in each of the second plurality of blocks;
cluster the new records based on the pairwise comparisons to generate a second set of clusters;
determine, for each cluster of the second set of clusters, if the cluster corresponds to a cluster of the first set of clusters;
when the cluster of the second set of clusters corresponds to a cluster of the first set of clusters, assign the UID of the cluster of the first set of clusters to the cluster of the second set of clusters; and
when the cluster of the second set of clusters does not correspond to a cluster of the first set of clusters, assign a new UID to the cluster of the second set of
clusters.

14. The system of claim 12, wherein the one or more blocking rules comprise a phonetic matching rule.

15. The system of claim 12, wherein the one or more blocking rules comprise equal address double metaphone and equal first name Soundex, wherein the records are grouped into a same block if either rule is satisfied.

16. The system of claim 12,
wherein each pairwise comparison comprises a comparison field and at least one comparison level,
wherein each comparison level is associated with a match weight, wherein the match weight is determined at least in part by training a model using an expectation maximization algorithm.

17. The system of claim 16, wherein the comparison field comprises first name and the comparison levels comprise Jaro-Winkler similarity and Levenshtein distance.

18. The system of claim 12, wherein the instructions are further configured to cause the system to:
determining, for at least one field, a term frequency adjustment,
wherein the term frequency adjustment is used to adjust a match weight based on a frequency of a value of the at least one field in the first dataset and the second dataset.

19. The system of claim 12, wherein the first dataset and the second dataset comprise a customer dataset and a marketing dataset, wherein the customer dataset includes account numbers associated with customers.

20. The system of claim 12, wherein preprocessing further comprises at least one of: converting dates to a standardized format, removing leading whitespace, removing trailing whitespace, removing prefixes, or removing suffixes.
